(19) United States
(12) Patent Application Publication
(10) Pub. No.: US 2018/0322273 A1
(43) Pub. Date: Nov. 8, 2018

(54) METHOD AND APPARATUS FOR LIMITED STARTING AUTHORIZATION

(71) Applicant: GM GLOBAL TECHNOLOGY OPERATIONS LLC, Detroit, MI (US)

(72) Inventors: William A. Biondo, Beverly Hills, MI (US); David T. Proefke, Troy, MI (US); Fred W. Huntzicker, Ann Arbor, MI (US)

(21) Appl. No.: 15/586,766

(22) Filed: May 4, 2017

(51) Int. Cl. G06F 21/44; B60R 25/04; G06K 19/07; B60R 16/023; B60R 25/24; B60R 25/01

(52) U.S. Cl. CPC G06F 21/44; B60R 25/04; G06K 19/0723; B60R 2025/1016; B60R 25/24; B60R 25/01; B60R 16/023

(57) ABSTRACT

A method and apparatus for limited starting authorization are provided. The method includes: determining whether an authorized wireless device is connected to a vehicle sharing system and whether a first command is received from the authorized wireless device; in response to determining that the authorized wireless device is connected to the vehicle sharing system and that the first command is received from the authorized wireless device, setting a timer to a predetermined value, enabling an authenticating device and notifying of the enabling of the authenticating device; and in response to determining that attempted access to an unauthorized part of the vehicle has occurred, a second command is received from the authorized wireless device, or the timer has expired, disabling the authenticating device and notifying of the disabling of the authenticating device. The method may be used in by vehicle sharing system to limit access and prevent theft.

Apparatuses and methods consistent with exemplary embodiments relate to providing authorization to start a vehicle. More particularly, apparatuses and methods consistent with exemplary embodiments relate to enabling authenticating devices capable of starting vehicles.

### SUMMARY

One or more exemplary embodiments provide a method and an apparatus that enable an authenticating device based on a connection to a mobile device. More particularly, one or more exemplary embodiments provide a method and an apparatus that limit the period for which an authenticating device is enabled based on conditions that trigger the disabling of the authentication device, thereby limiting the starting authorization of a shared vehicle.

According to an aspect of exemplary embodiment, a method for limited starting authorization is provided. The method includes: determining whether an authorized wireless device is connected to a vehicle sharing system and whether a first command is received from the authorized wireless device; in response to determining that the authorized wireless device is connected to the vehicle sharing system and that the first command is received from the authorized wireless device, setting a timer to a predetermined value, enabling an authenticating device and notifying of the enabling of the authenticating device; and in response to determining that attempted access to an unauthorized part of the vehicle has occurred, a second command is received from the authorized wireless device, or the timer has expired, disabling the authenticating device and notifying of the disabling of the authenticating device.

The first command may include at least one from among an unlock command or an enable command. The second command may include at least one from among a lock command or a disable command.

The authorized wireless device may include a mobile phone connectable to the vehicle sharing system via at least one from among Bluetooth, Cellular Signal, and Wi-Fi.

The authenticating device may include at least one from among a key fob, a card, and an RFID transceiver.

The authenticating device may be configured to unlock a vehicle.

According to an aspect of exemplary embodiment, a method for limited starting authorization is provided, the method includes: connecting an authorized wireless device to a vehicle sharing system; sending a first command from the authorized wireless device to the vehicle sharing system; receiving a notification indicating that the authenticating device is enabled in response to the authorized wireless device being connected to the vehicle sharing system; and receiving a notification indicating that the authenticating device is disabled in response to at least one from among attempted access to an unauthorized part of the vehicle, a second command being received from the authorized wireless device, and a timer being expired.

The first command may include at least one from among an unlock command and an enable command. The second command may include at least one from among a lock command and a disable command.

The connecting may be performed via at least one from among a Bluetooth signal, a Cellular Signal and a Wi-Fi Signal.

The authenticating device may include at least one from among a key fob, a card, and an RFID transceiver.

The authenticating device may be configured to unlock a vehicle.

According to an aspect of an exemplary embodiment, a non-transitory computer readable medium comprising instructions executable to perform the method for limited starting authorization is provided.

According to an aspect of an exemplary embodiment, an apparatus for providing limited starting authorization is provided. The apparatus includes: at least one memory comprising computer executable instructions; and at least one processor configured to read and execute the computer executable instructions. The computer executable instructions causing the at least one processor to determine whether an authorized wireless device is connected to a vehicle sharing system and whether a first command is received from the authorized wireless device, in response to determining that the authorized wireless device is connected to the vehicle sharing system and that the first command is received from the authorized wireless device, set a timer to a predetermined value, enable an authenticating device and notify of the enabling of the authenticating device, and in response to determining that attempted access to an unauthorized part of the vehicle has occurred, a second command is received from the authorized wireless device, or the timer has expired, disable the authenticating device and notify of the disabling of the authenticating device.

The first command may include at least one from among an unlock command or an enable command. The second command may include at least one from among a lock command or a disable command.

The authorized wireless device may be a mobile phone connectable to the vehicle sharing system via at least one from among Bluetooth, Cellular Signal, and Wi-Fi.

The authenticating device may include at least one from among a key fob, a card, and an RFID transceiver.

The authenticating device may be configured to unlock a vehicle.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that provides limited starting authorization according to an exemplary embodiment;

FIG. 2 shows an illustrative diagram of a system that provides limited starting authorization according to an exemplary embodiment;

FIG. 3 shows a flowchart for a method of providing limited starting authorization according to an exemplary embodiment;

FIG. 4 shows a flowchart for a method of providing limited starting authorization according to an exemplary embodiment; and

FIG. 5 shows a flowchart for a method of providing limited starting authorization according to an exemplary embodiment.

### DETAILED DESCRIPTION OF EXEMPLARY EMBODIMENTS

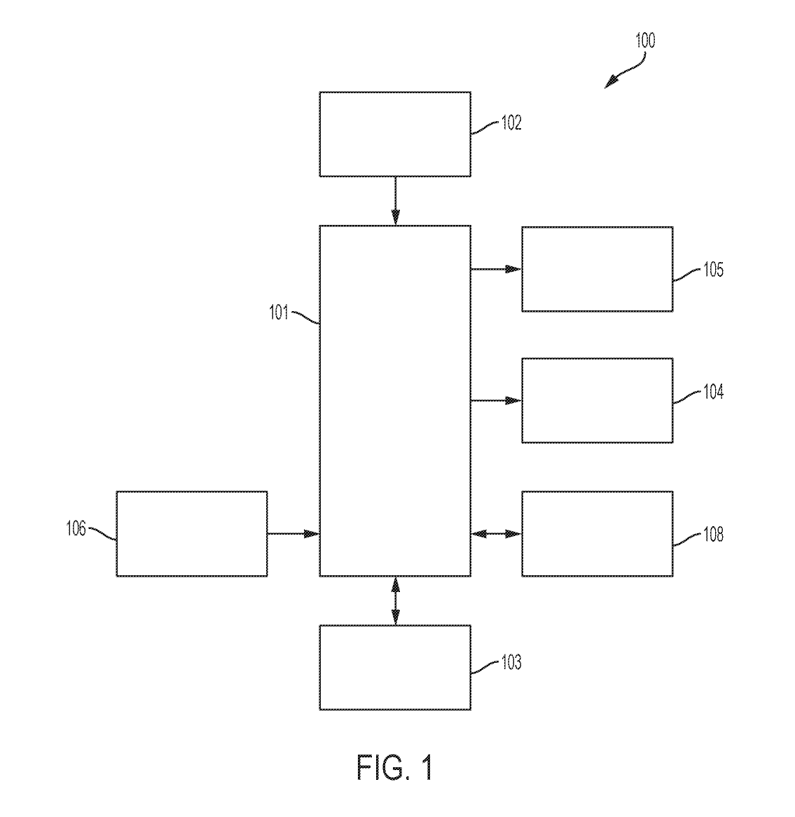

An apparatus and method that provide limited starting authorization will now be described in detail with reference to FIGS. 1-5 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

As vehicle sharing services grow, there is a need for a convenient way to provide authorization to start or access shared vehicles. For example, authorization may be granted to start a vehicle, open a vehicle door, and drive a vehicle to certain locations. One method of authorizing a user may include authenticating a user via a card such a magnetic swipe card, a radio frequency card, a key fob, or a near field communication card. Another method of authorizing a user may include authorizing a portable electronic device such as a mobile phone to provide access to a vehicle. However, authorization needs to be limited to prevent unauthorized access to or use of a shared vehicle.

In one example, a large radio frequency range may not allow for physical proximity to be confirmed. Thus, this may be a cause for un-authorized usage of a person's device while it is at a distance from a vehicle. Accordingly, the method and apparatus disclosed herein may address such issues.

FIG. 1 shows a block diagram of an apparatus that provides limited starting authorization 100 according to an exemplary embodiment. As shown in FIG. 1, the apparatus that provides limited starting authorization 100, according to an exemplary embodiment, includes a controller 101, a power supply 102, a storage 103, an output 104, an authentication device 105, a user input 106, and a communication device 108. However, the apparatus that provides limited starting authorization 100 is not limited to the aforementioned configuration and may be configured to include additional elements and/or omit one or more of the aforementioned elements. The apparatus that provides limited starting authorization 100 may be implemented as part of a vehicle, as a standalone component, as a hybrid between an on vehicle and off vehicle device, or in another computing device.

The controller 101 controls the overall operation and function of the apparatus that provides limited starting authorization 100. The controller 101 may control one or more of a storage 103, an output 104, an authentication device 105, a user input 106, and a communication device 108 of the apparatus that provides limited starting authorization 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the authentication device 105, the user input 106, and the communication device 108 of the apparatus that provides limited starting authorization 100. The information may be sent and received via a bus or network, or may be directly read or written to/from one or more of the storage 103, the output 104, the user input 106, and the communication device 108 of the apparatus that provides limited starting authorization 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the authentication device 105, the user input 106, and the communication device 108, of the apparatus that provides limited starting authorization 100. The power supply 102 may include one or more from among a battery, an outlet, a capacitor, a solar energy cell, a generator, a wind energy device, an alternator, etc.

The storage 103 is configured for storing information and retrieving information used by the apparatus that provides limited starting authorization 100. The storage 103 may be controlled by the controller 101 to store and retrieve information received from the authentication device 105 and/or communication device 108. The information may include authentication information received via authentication device 105 or authorization information received via communication device 108. The storage 103 may also include the computer instructions configured to be executed by a processor to perform the functions of the apparatus that provides limited starting authorization 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that provides limited starting authorization 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the enabling of the authenticating device or the disabling of the authenticating device. In addition, the output 104 may output a request for authorization and an indication that indicates whether a user is authorized or unauthorized.

The authentication device 105 is configured to authenticate an operator of a vehicle. For example, the authentication device may be a receiver configured to receive an authentication code or signal. After receiving the authentication code or signal and after it is determined that the authentication code or signal is authorized, the authentication device 105 may control to enable functions of a vehicle. For example, the authentication device may control to power on a vehicle, start a vehicle, unlocking a door, or control a door, hood and/or trunk of a vehicle.

The authentication device 105 may be enabled by the controller 101 in response to detecting a connection from an authorized mobile device such as a cell phone. Alternatively, the authentication device 105 may be disabled by the controller in response to a predetermined condition. Examples of predetermined conditions may include a hood or door being ajar, a second command being received from the authorized wireless device, an expired timer, etc.

The user input 106 is configured to provide information and commands to the apparatus that provides limited starting authorization 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc.

The user input 106 may be configured to receive a user input to acknowledge or dismiss the notification output by the output 104. The user input 106 may also be configured to receive a user input to connect an authorized wireless device, turn off a vehicle, and enter a password or other code to authorize a wireless device, etc.

The communication device 108 may be used by apparatus that provides limited starting authorization 100 to communicate with various types of external apparatuses according to various communication methods. The communication device 108 may be used to send/receive information from a wireless device. For example, the communication device 108 may send/receive information to connect a wireless device to a vehicle sharing system, authorize a wireless device with the vehicle sharing system, and enable access to vehicle by enabling an authentication device after authorizing the wireless device.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, WI-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that provides limited starting authorization 100 may be configured to determine whether an authorized wireless device is connected to a vehicle sharing system and whether a first command is received from the authorized wireless device, in response to determining that the authorized wireless device is connected to the vehicle sharing system and that the first command is received from the authorized wireless device, set a timer to a predetermined value, enable an authenticating device and notify of the enabling of the authenticating device, and in response to determining that attempted access to an unauthorized part of the vehicle has occurred, a second command is received from the authorized wireless device, or the timer has expired, disable the authenticating device and notify of the disabling of the authenticating device.

According to an exemplary embodiment, the controller 101 of the apparatus that provides limited starting authorization 100 may be configured to connect to an authorized wireless device to a vehicle sharing system, send a first command from the authorized wireless device to the vehicle sharing system, receive a notification indicating that the authenticating device is enabled in response to the authorized wireless device being connected to the vehicle sharing system, and receive a notification indicating that the authenticating device is disabled in response to at least one from among attempted access to an unauthorized part of the vehicle, a second command being received from the authorized wireless device, and a timer being expired. In one example, attempting access to an unauthorized part of the vehicle may be a condition or parameter that indicates that a hood is ajar or opened, or that part of a vehicle has been removed or is being tampered with.

The first command may include an unlock command or an enable command and the second command may include a lock command or a disable command.

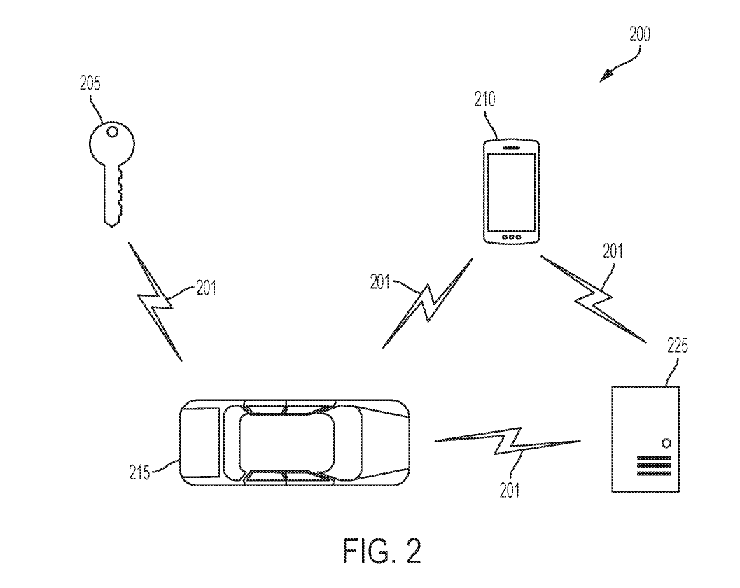

FIG. 2 shows an illustrative diagram of a vehicle sharing system 200 that provides limited starting authorization according to an exemplary embodiment. Referring to FIG. 2, a vehicle sharing system 200 may be present in a vehicle 215 or may be a combination of an on-vehicle system and a server system 220 connected to the vehicle system via a network 201.

A mobile device 210 connects to the vehicle sharing system 200 and be authorized by the vehicle sharing system 200. After the mobile device 210 is authorized, the vehicle sharing system 200 enables the authentication device 205. The authentication device 205 may be then used to access the vehicle, functions of the vehicle, and/or start the vehicle. However, the authentication device 205 may only be enabled for a preset amount of time and may be disabled in response to other conditions.

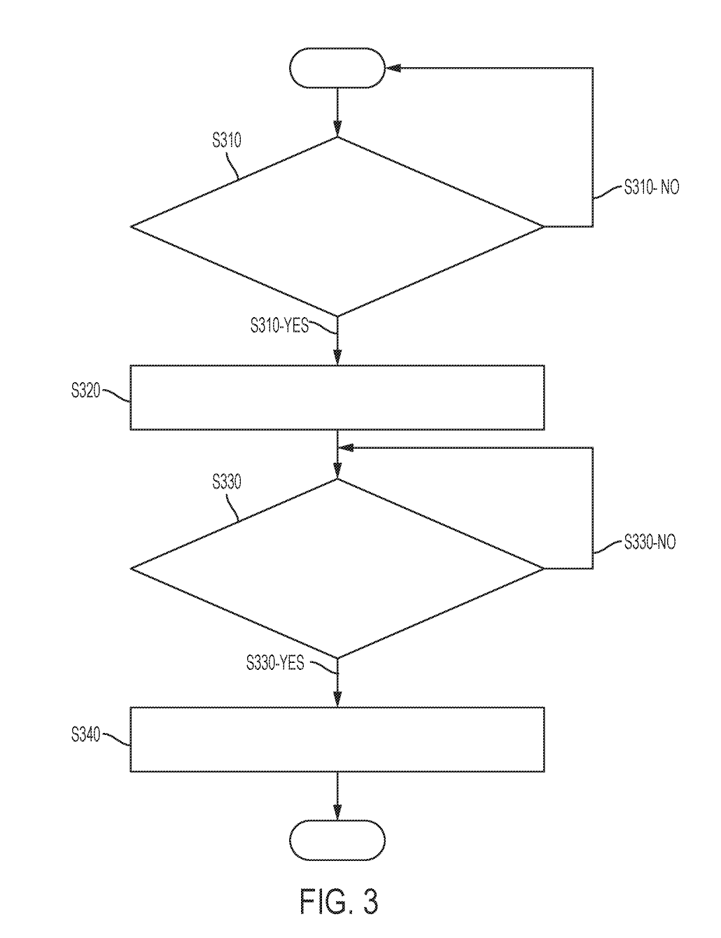

FIG. 3 shows a flowchart for a method of providing limited starting authorization according to an exemplary embodiment. The method of FIG. 3 may be performed by the apparatus that provides limited starting authorization 100 or may be encoded into a computer readable medium as instructions that are executable by a computer to perform the method.

Referring to FIG. 3, a check for a connection to a mobile device is performed in operation S310 and operation S310—NO. If an authorized wireless device is connected to a vehicle sharing system and a first command is received from the authorized wireless device in operation S310 (operation S310—YES), the authenticating device is enabled and a notification of the enablement of the authenticating device is provided in operation S320. In operation S330 and operation S330—NO, a check for a condition to disable the authenticating device is performed. For example, the condition may include attempted access to an unauthorized part of the vehicle, a second command being received from the authorized wireless device, or a timer being expired. If the condition is met (operation S330—YES), then the authenticating device is disabled and a notification notifying of the authenticating device being disabled is output in operation S340. In one example, the attempted access to an unauthorized part of the vehicle may indicate that a hood is ajar or opened, and/or unexpected access to rotating components.

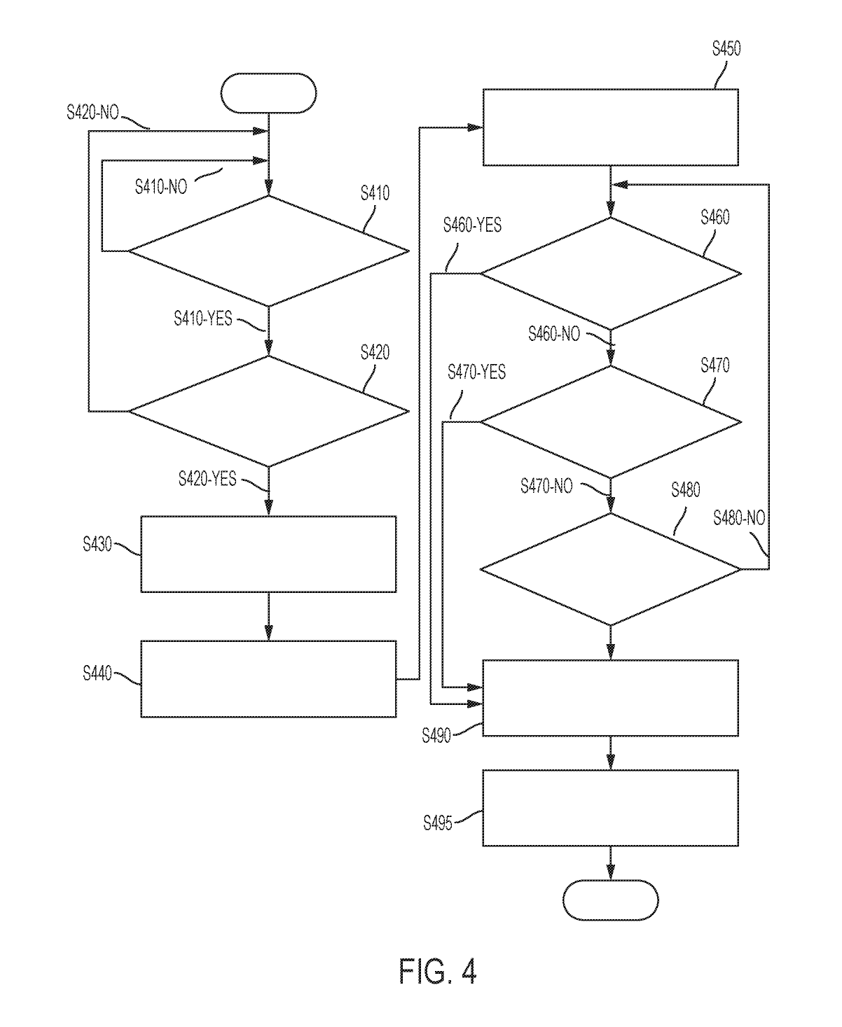

FIG. 4 shows a flowchart for a method of providing limited starting authorization according to an exemplary embodiment. The method of FIG. 4 may be performed by the apparatus that provides limited starting authorization 100 or may be encoded into a computer readable medium as instructions that are executable by a computer to perform the method.

Referring to FIG. 4, a check to determine whether an authorized wireless device is connected to the vehicle sharing system is performed in operation S410—operation S410—No. After the authorized wireless device is connected to the vehicle sharing system, it is determined whether a first command is received from the authorized wireless device in operations S420 an S420—No. The first command may be an unlock command to unlock the vehicle or an enable command to enable a function of the vehicle.

In response to receiving the first command (operation S420—YES), an enablement timer is set to calibrated or predetermined value in operation S430, a notification notifying that the authentication device is enabled is output in operation S440, and the authentication device is enabled in operation S450. In one example of enabling an authentication device, power may be provided to a FOB.

In operation S460, it is determined whether attempted access to an unauthorized part of the vehicle has occurred. If the attempted access to an unauthorized part of the vehicle has occurred (operation S460—YES), the method jumps to operation S490. If attempted access to an unauthorized part of the vehicle has not occurred (operation S460—NO), it is determined whether a second command is received from the wireless device (operation S470). The second command may be a lock command or a disable command to lock or disable the vehicle.

If the second command is received from the wireless device (operation S470—YES), the method jumps to operation S490. If the second is not received from the wireless device (operation S470—NO), it is determined whether the timer is expired in operation S480.

If the timer is expired (operation S480—YES), the method jumps to operation S490. If the timer is not expired (operation S480—NO), the method returns to operation S460. The authentication device is disabled in operation S490 and a notification or feedback that the authentication device is disabled is output in operation S495.

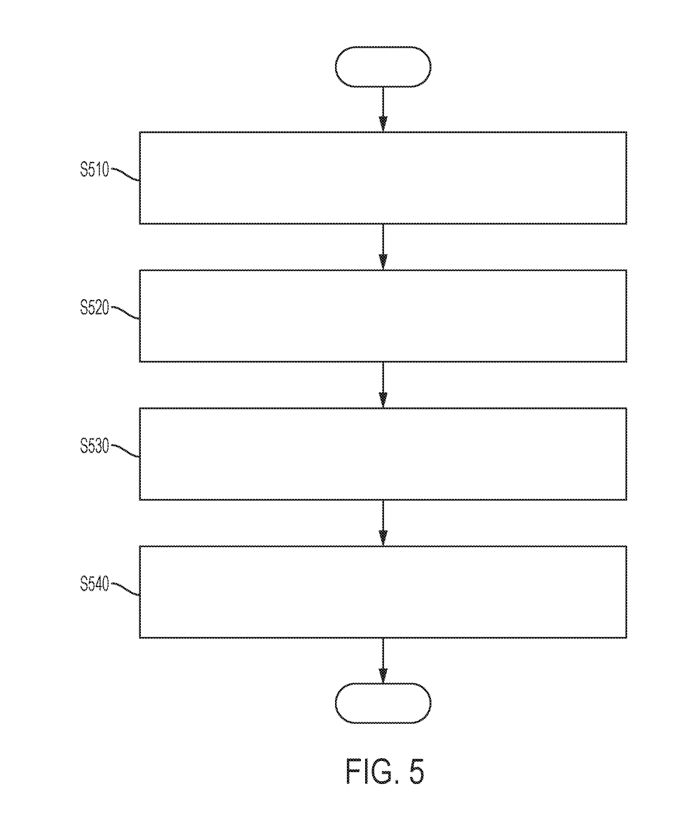

FIG. 5 shows a flowchart for a method of providing limited starting authorization according to an exemplary embodiment. The method of FIG. 5 may be performed by the apparatus that provides limited starting authorization 100 or may be encoded into a computer readable medium as instructions that are executable by a computer to perform the method.

Referring to FIG. 5, connecting an authorized wireless device to a vehicle sharing system is performed in operation S510. A first command is sent from the authorized wireless device to the vehicle sharing system in operation S520. After the first command is sent, a notification indicating that the authenticating device is enabled is received after the authorized wireless device being connected to the vehicle sharing system in operation S530. Finally, a notification indicating that the authenticating device is disabled is received in operation S540. The notification may be received in response to attempted access to an unauthorized part of the vehicle, a second command being received from the authorized wireless device, or a timer being expired. The first command may be an unlock command or an enable command, and the second command may be a lock command or a disable command.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for limited starting authorization, the method comprising:
determining whether an authorized wireless device is connected to a vehicle sharing system and whether a first command is received from the authorized wireless device;
in response to determining that the authorized wireless device is connected to the vehicle sharing system and that the first command is received from the authorized wireless device, setting a timer to a predetermined value, enabling an authenticating device and notifying of the enabling of the authenticating device; and
in response to determining that attempted access to an unauthorized part of the vehicle has occurred, a second command is received from the authorized wireless device, or the timer has expired, disabling the authenticating device and notifying of the disabling of the authenticating device.

2. The method of claim 1, wherein the first command comprises at least one from among an unlock command or an enable command.

3. The method of claim 2, wherein the second command comprises at least one from among a lock command or a disable command.

4. The method of claim 1, wherein the authorized wireless device comprises a mobile phone connectable to the vehicle sharing system via at least one from among Bluetooth, Cellular Signal, and Wi-Fi.

5. The method of claim 1, wherein the authenticating device comprises at least one from among a key fob, a card, and an RFID transceiver.

6. The method of claim 5, wherein the authenticating device is configured to unlock a vehicle.

7. A non-transitory computer readable medium comprising instructions executable to perform the method of claim 1.

8. A method for limited starting authorization, the method comprising:
connecting an authorized wireless device to a vehicle sharing system;
sending a first command from the authorized wireless device to the vehicle sharing system;
receiving a notification indicating that the authenticating device is enabled in response to the authorized wireless device being connected to the vehicle sharing system; and
receiving a notification indicating that the authenticating device is disabled in response to at least one from among attempted access to an unauthorized part of the vehicle, a second command being received from the authorized wireless device, and a timer being expired.

9. The method of claim 8, wherein the first command comprises at least one from among an unlock command and an enable command.

10. The method of claim 9, wherein the second command comprises at least one from among a lock command and a disable command.

11. The method of claim 8, wherein the connecting is performed via at least one from among a Bluetooth signal, a Cellular Signal and a Wi-Fi Signal.

12. The method of claim 8, wherein the authenticating device comprises at least one from among a key fob, a card, and an RFID transceiver.

13. The method of claim 12, wherein the authenticating device is configured to unlock a vehicle.

14. A non-transitory computer readable medium comprising instructions executable to perform the method of claim 8.

15. An apparatus for providing limited starting authorization, the apparatus comprising:
at least one memory comprising computer executable instructions; and
at least one processor configured to read and execute the computer executable instructions, the computer executable instructions causing the at least one processor to:
determine whether an authorized wireless device is connected to a vehicle sharing system and whether a first command is received from the authorized wireless device;
in response to determining that the authorized wireless device is connected to the vehicle sharing system and that the first command is received from the authorized wireless device, set a timer to a predetermined value, enable an authenticating device and notify of the enabling of the authenticating device; and
in response to determining that attempted access to an unauthorized part of the vehicle has occurred, a second command is received from the authorized wireless device, or the timer has expired, disable the authenticating device and notify of the disabling of the authenticating device.

16. The apparatus of claim 15, wherein the first command comprises at least one from among an unlock command or an enable command.

17. The apparatus of claim 16, wherein the second command comprises at least one from among a lock command or a disable command.

18. The apparatus of claim 15, wherein the authorized wireless device comprises a mobile phone connectable to the vehicle sharing system via at least one from among Bluetooth, Cellular Signal, and Wi-Fi.

19. The apparatus of claim 15, wherein the authenticating device comprises at least one from among a key fob, a card, and an RFID transceiver.

20. The apparatus of claim 19, wherein the authenticating device is configured to unlock a vehicle.
